(19) United States
(12) Patent Application Publication
(10) Pub. No.: US 2007/0162669 A1
(43) Pub. Date: Jul. 12, 2007

(54) Remote sensor with modular bus adapter

(76) Inventors: Wayne W. Martin, Fairfax, VA (US); Gilbert T. Williams, Baltimore, MD (US)

Correspondence Address: ROBERTS, MLOTKOWSKI & HOBBES, P. O. BOX 10064, MCLEAN, VA, 22102-8064, US

(21) Appl. No.: 11/328,361

(22) Filed: Jan. 9, 2006

(51) Int. Cl. G06F 13/38

(52) U.S. Cl. 710/72

(57) ABSTRACT

A remote sensing system having a modular bus architecture. The bus architecture of the present invention comprises a modular reconfigurable processing unit which functions as an interface between the sensors and the communications components. The system has three main components: (1) input pods that provide physical and logical interfaces to whatever sensors (similar or dissimilar) are to be used, (2) output pods that provide physical and logical interfaces to whatever communications devices (similar or dissimilar) are to be used, and (3) a reconfigurable interface and processing unit that accepts both the input and output pods as plug-in devices and that provides control, format conversion, data buffering, data manipulation, power management, and other needed services for inputting the data, processing the data, and transmitting the data, regardless of the sensor type or communications device.

### BACKGROUND

1. Field of the Invention

The present invention relates generally to sensor and communication systems, and more particularly to unattended sensing systems and the components and architecture thereof.

2. Background of the Invention

For quite some time, governments have used both active and passive detection systems to remotely track and detect various conditions, persons and physical objects. Intelligence applications include the use of satellite-based sensors including high-resolution cameras, infrared, and radio direction finding equipment, as well as locally placed sensors to detect acoustic, magnetic and other physical properties to covertly monitor areas of interest. Only recently have economies of scale and new manufacturing efficiencies and techniques permitted using derivatives of these technologies for commercial applications.

Given today's geo-political climate and the increasing need to monitor various activities, facilities and conditions, sensing devices have taken on even more importance in day to day intelligence gathering. As these systems continue to be deployed for an ever expanding class of purposes, it is desirable that the designs provide increased flexibility, scalability and modularity.

Sensors may be employed for a wide variety of purposes requiring different sensor technologies. These sensor technologies include, but are not limited to, capacitive sensors, displacement sensors, inductive sensors, infrared sensors, magnetic sensors, optical sensors, pressure sensors, temperature sensors, ultrasonic sensors, chemical sensors, biological sensors and radiological sensors.

There are two broad classes of sensing applications. Sensors may be operated either in situ or in a standoff mode to monitor a parameter of interest. Standoff sensors are often used for phenomena that emit or reflect an observable radiation, and are situated at some distance from the object or phenomenon being observed. In the case of in situ sensing, data capture occurs at the physical location of the phenomenon being observed. In remote sensing (remote monitoring and control) applications, for both standoff and in situ sensors, it is often necessary for sensor control to be provided from a location which may be a great distance from the physical location of the sensor. With remote sensing, data reporting must also be transmitted to a location which may be significantly distant from the sensor location.

In the case of non-commercial remote sensing applications, a wide range of sensing/monitoring missions are possible. Examples include placing sensors: (1) at locations at significant distances from military and civilian personnel to provide warning of approaching threats; (2) in unoccupied buildings to determine occupancy or infiltration; (3) along travel corridors and intersections to detect unusual or potentially threatening activity; and (4) at sites in denied areas to assess threat potential.

While discrete in situ and short range standoff sensors are capable of capturing the required data using specialized purpose-built systems and are relatively easily operated, remote monitoring applications of these sensors present more challenging data gathering tasks. For example, standoff sensing (e.g., optical, infrared, radar) applications from air or space platforms can not offer sensing capability for many parameters of interest, such as vibration and acoustics, chemical agent plumes, air or waterborne biologics, optical or infrared signatures from building interiors or beneath structures (e.g., overpasses), magnetic signatures and the like.

Remote sensing applications as currently practiced also provide additional difficulties. Sensors used for remote applications must be, by definition, unattended. Current unattended sensing systems are generally “specialty purpose-built.” That is, they are designed to provide high value monitoring with regard to a small number of physical characteristics (e.g., weight or volume), but do so at the expense of offering limited flexibility and limited performance in monitoring or capturing other parameters. Such systems often cannot be effectively used in environments or for missions other than those for which they were specifically designed. Additionally, as the component technologies improve, these systems cannot exploit the applicable advances except through a substantial redesign and redeployment. This can often provide too costly or time consuming to warrant the change.

Yet another limitation of existing purpose-built systems for remote sensing applications is that they usually have sensors and communications devices integrated into a single package. Although this can optimize a characteristic such as package volume, the resulting system and in-place sensing technology can not be used for applications that call for a different communications device (e.g., greater range, different frequency, alternative operational protocols). Because of incompatibilities with alternate devices, it is necessary to replace the entire system with a different purpose built system if an alternate communications device is required.

Another disadvantage of most existing remote sensing systems is that interconnecting heterogeneous sensors into a system requires several proprietary components from different vendors. Still further, connecting a single input into multiple output networks requires special system hardware/software/firmware, which cannot be easily reconfigured.

In addition to the aforementioned drawbacks, existing remote sensing system designs also suffer from limited scalability. In other words, with these fixed size units, the ability to provide additional sensor connectivity is limited or unavailable. Further, given the limited sizing of these units, as sensing needs increase or become more varied, the needs can often not be accommodated due to limitations in network connectivity and topology capabilities.

What is needed, therefore, is a sensing system and flexible modular bus architecture which provides a remote monitoring and control capability that can be rapidly configured for a broader set of applications and missions. What is also needed is a sensor system and methodology wherein the latest sensing technologies and improvements can be incorporated with a minimal degree of cost and effort.

### SUMMARY OF THE INVENTION

It is therefore a primary object of the present invention to address to aforementioned limitations in the prior art.

It is a further object of the present invention provide a remote sensing system and methodology which offers a high degree of flexibility, scalability and connectivity when and as deployed.

It is another object of the present invention to provide a remote sensing system and methodology which provides scalability in that additional sensing units and communications devices may easily be added.

It is a still further object of the present invention to provide a remote sensing system and methodology which provides a high degree of flexibility in terms of accommodating a large variety of connectors and data formats with minimal or no modifications to the primary apparatus.

It is a yet further object of the present invention to provide a remote sensing device and methodology that provides maximum flexibility in network connectivity and topology capabilities.

It is another object of the present invention to provide a remote sensing device and methodology in which flexibility in terms of system control and architectural flexibility is maximized.

It is a still further object of the present invention to provide a remote sensing system and methodology which allows flexibility in terms of deployments and missions.

It is another object of the present invention to provide such a flexible system which allows for remote, software-based changes to the system to modify system operation in response to changing deployments and missions.

These and other objects of the present invention are obtained through the use of a novel remote sensing system having a modular bus architecture. The bus architecture of the present invention comprises a modular reconfigurable processing unit which functions as an interface between the sensors and the communications components. The sensing system has three main components: (1) input pods that provide physical and logical interfaces to whatever sensors (similar or dissimilar) are to be used, (2) output pods that provide physical and logical interfaces to whatever communications devices (similar or dissimilar) are to be used, and (3) a reconfigurable interface and processing unit that accepts both the input and output pods as plug-in devices and that provides control, format conversion, data buffering, data manipulation, power management, and other needed services for inputting the data, processing the data, and transmitting the data, regardless of the sensor type or communications device.

Modular software running on the system enables functions such as sensor control, signal processing, detection processing, decision logic, alert generation, activity scheduling, data encryption and encoding, tamper protection, and temporary and long term data storage. Given these advantages, a short development time for new sensor and communications component interfaces allows users to maintain operational capability across a range of evolving and presently unanticipated missions.

Accordingly, it is a further object of the present invention to provide a modular bus adapter comprising a communications bus, a reconfigurable processing unit communicating with said communications bus, said reconfigurable processing unit operable to process input data to generate output data, a configuration modification means communicating with said reconfigurable processing unit for modifying the operation of said reconfigurable processing unit, first and second input/output interconnects communicating with said communications bus, at least one input pod connected to said first input/output interconnect, for receiving said input data and transmitting said input data to said reconfigurable processing unit for processing to generate said output data, and at least one output pod, connected to said second input/output interconnect, for transmitting said output data to a communications device wherein said configuration modification means is operable to modify the operation of said reconfigurable processing unit to permit said modular bus adapter to accept a plurality of different formats of input data and to transmit a plurality of different formats of output data.

These and other advantages and features of the present invention are described herein with specificity so as to make the present invention understandable to one of ordinary skill in the art.

### BRIEF DESCRIPTION OF THE DRAWINGS

The above objects and other advantages of the present invention will become more apparent by describing in detail the preferred embodiments thereof with reference to the attached drawings in which:

FIG. 1 is a schematic diagram illustrating the components of the remote sensing system of the present invention in a preferred embodiment thereof;

FIG. 2 is a detailed schematic diagram illustrating the modular bus adapter architecture and the components of the IPU of the present invention in a preferred embodiment;

FIG. 3 is a schematic diagram of the input/output architecture of an I/O pod and the related conversion data flow process occurring therein in a preferred embodiment of the invention;

FIG. 4 is a schematic diagram of the input/output architecture of an interconnect processing unit and the related data flow process occurring therein in a preferred embodiment of the invention;

FIG. 5 is a flowchart illustrating the method for processing unit configuration according to a preferred embodiment of the invention; and

FIG. 6 is a diagram representing exemplary interconnection and networking deployments of the system of the present invention according to various preferred embodiments.

### DETAILED DESCRIPTION OF THE INVENTION

The present invention for a remote sensing system and methodology is now described generally with additional details following the general description now provided.

The present invention comprises a remote sensing system which includes an Interconnect and Processing Unit (IPU) which functions as an interface between sensors and communications components. The present invention further comprises a process for sensing according to the teachings herein. In the description that follows, numerous specific details are set forth for the purposes of explanation. It will, however, be understood by one of skill in the art that the invention is not limited thereto and that the invention can be practiced without such specific details and/or substitutes therefor. The present invention is limited only by the appended claims and may include various other embodiments which are not particularly described herein but which remain within the scope and spirit of the present invention.

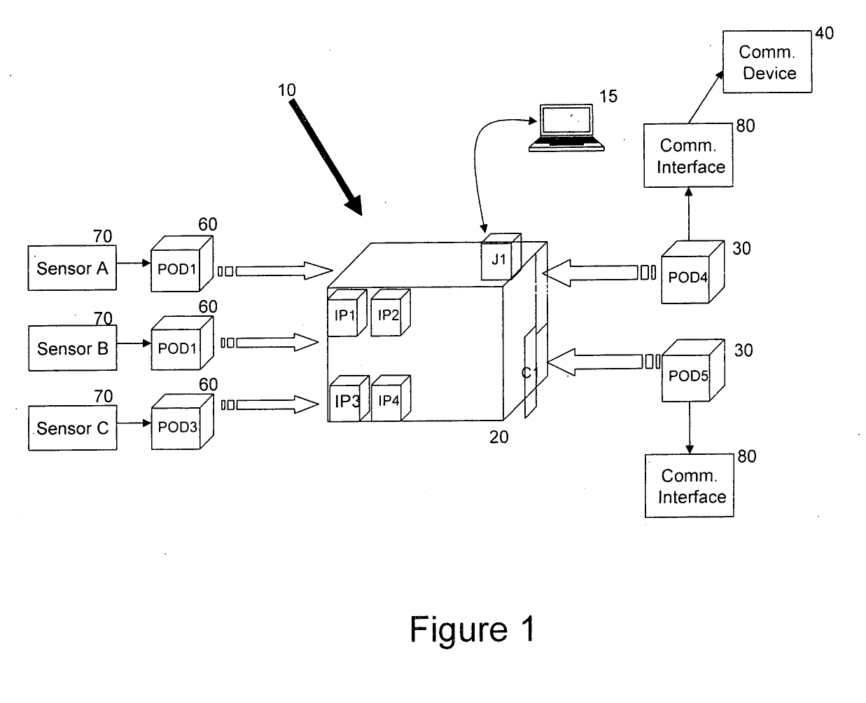

FIG. 1 is a block diagram of the system 10 of the present invention in a preferred embodiment thereof. The system 10 has three main components: (1) input pods 60 that provide physical and logical interfaces to whatever sensors 70 (similar or dissimilar) are to be used, (2) output pods 30 that provide physical and logical interfaces to whatever communications devices 40 (similar or dissimilar) are to be used, and (3) a reconfigurable interface and processing unit (IPU) 20 that accepts both the input and output pods 60 and 30 as plug-in devices and that provides control, format conversion, data buffering, data manipulation, power management, and other needed services for inputting the data, processing the data, and transmitting the data, regardless of the sensor type or communications device.

Modular software running on IPU 20 enables functions such as sensor control, signal processing, detection processing, decision logic, alert generation, activity scheduling, data encryption and encoding, tamper protection, and temporary and long term data storage. A short development time for new sensor and communications component interfaces allows users to maintain operational capability across a range of evolving and presently unanticipated missions.

System setup for IPU 20 is preferably via a configuration device 15 that may comprise software hosted on, for example, a personal computer or PDA type device. Through a communications interface with IPU 20, the configuration wizard, which is described in greater detail below, allows the user to specify the set of input and output devices to be used for the particular application. The wizard then sets the appropriate configuration, including the needed software modules and parameter settings, in IPU 20. More details on this process are provided below. The modular hardware, firmware and software architectures of the present invention allow deployed sensing units to operate individually, in clusters, in hierarchical configurations, or as elements of a larger scale monitoring or command and control system. IPU 20 preferably includes means for reconfiguring the hardware, software and/or firmware resident in IPU 20, as well as a plurality of conversion algorithms for converting input data to processed data.

Each input pod 60 and output pod 30 includes a standard connection mechanism to interface with the input/output connections of the IPU 20 unit. Multiple types of input/output pods (e.g., serial pods, USB pods, analog pods, etc.) may be employed to gather data from a variety different sensor types 70 (e.g., radiation, chemical, image, etc.), and transmit data via a variety of different communications devices 40 (e.g., long-range, medium-range, short-range, etc.). Output pods 30 may, in one embodiment communicate with communications devices 40 via a communications interface 80.

Each specific input pod 60 provides mechanical, electrical, and data conversion functions for the input data received from an associated sensor 70 and sends this data via a communications bus to IPU 20. Each specific output pod type provides mechanical, electrical, and data conversion functions for output data sent from the reconfigurable processing unit to the communications bus and then to the external communications device.

Each input pod 60 and each output pod 30 preferably includes means for converting a digital signal from one signal type to a different signal type under software control. Each signal type is mapped to a unique identifier enabling the software to select a proper conversion algorithm. Each input pod 60 and each output pod 30 may communicate, via IPU 20, with other input/output pods for transmitting and receiving data under software control.

Now that a general description of the components of the present invention has been provided, a more detailed description now follows in connection with the Figures.

With continued reference to FIG. 1, a preferred embodiment 10 of the invention is disclosed. The embodiment has three main components: input pods 60 that provide physical and logical interfaces to sensors 70 which are used for receiving sensor data; output pods 30 that provide physical and logical interfaces to communications devices 40 through communications interfaces 80 and IPU 20 that accepts both the input 60 and output 30 pods as plug-in devices and that provides control, format conversion, data buffering, data manipulation, power management, and other needed services for receiving the data, processing the data, and transmitting the data.

As discussed in greater detail below, multiple types of input/output pods (e.g., serial pods, USB pods, analog pods, etc.) may be employed to gather data from a variety different sensor types (e.g., radiation, chemical, image, etc.) 70, and transmit data via a variety of different communications devices (e.g., long-range, medium-range, short-range, etc.) 40.

Various embodiments are possible with respect to the way that sensors 70 and communications devices 40 receive and transmit data from and to IPU 20. For example, sensors 70 may transmit data to pods over a wired connection or a wireless connection. In the case of a wireless connection various known protocols may be used for communication include those that provide encryption or otherwise protect the data from being accessed by unauthorized users. As with sensors 70, communications devices 40 may also communicate with IPU 20 and pods 30 via a wired or wireless interface. One or more communications interface devices 80, such as a router, Ethernet transceiver, and/or encryption device may also be logically located between an output pod 30 and an associated communication device 40, although this is not required.

Sensors 70 and communication devices 40 and communications interfaces 80 may be commercial off the shelf (COTS) devices or they may be military grade (MIL) devices. One of the benefits of the present invention is that they may be proprietary or standardized but in either case, so long as the appropriate pod 60 or 30 is used and configured properly, the devices may be incorporated into the sensing system on a plug and play basis. Further, once physically connected, they may be remotely activated and deactivated as well as reconfigured.

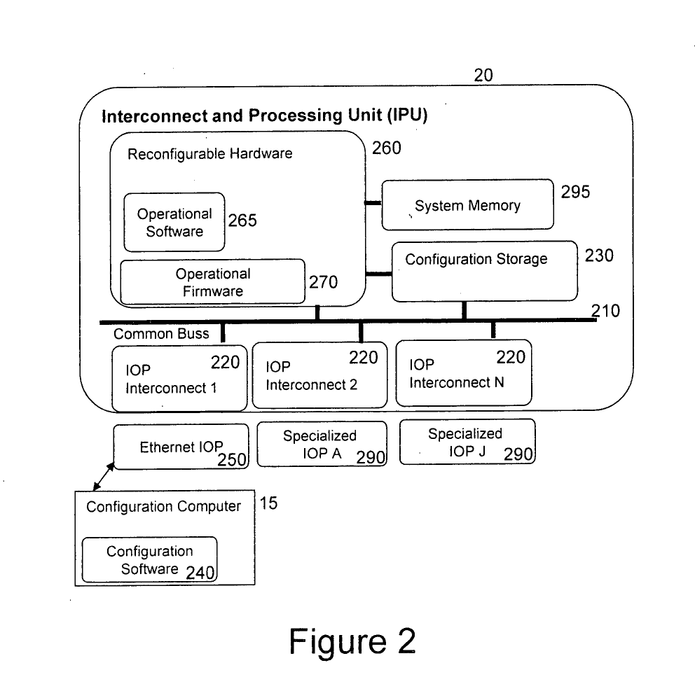

Referring now to FIG. 2, there is shown a more detailed schematic diagram of IPU 20 and the novel bus architecture as implemented in a preferred embodiment of the present invention. The modular bus adapter functionality comprises a common communications bus 210 connecting IPU 20 and a plurality of input/output interconnects 220. One or more input pods 60 and one or more output pods 30 (collectively “I/O Pods”) may be connected to a corresponding input/output interconnect 220 via common bus 210. Input pods 60 in turn are connected to a data gathering (“receiving”) sensor device 70 and output pods 30 are connected to a data export (“transmission”) communications interface device 80, which is selected depending on the desired functionality or mission for remote sensing system 10.

Remote sensing system 10 also includes a configuration device 15 that also communicates with other components via communications bus 210. One such component is configuration storage 230 which is a component of IPU 20 and may comprise, for example, a program embedded in an electrically erasable programmable read-only memory (EEPROM) chip, an erasable programmable read-only memory (EPROM) chip, and/or a programmable read-only memory (PROM) chip, or equivalent structure. The program or programs stored in configuration storage may be modified, added and/or deleted through user action via configuration device 15. In an alternative embodiment, configuration storage device 230 may be comprised of a disk drive, CD or other storage medium internal or external to IPU 20.

Configuration device 15 preferably comprises a personal computer or personal digital assistant or some other computing device capable of storing and running configuration wizard software program 240. Configuration device 15 may be externally connected, via an Ethernet I/O Pod 250 for example, to configuration device 15 running configuration wizard software 240. The configuration wizard software program 240 preferably employs a user-friendly graphical user interface (GUI) to facilitate updates and modifications to IPU 20 including its software, the pods and other components thereof.

The configuration wizard software program 240 allows the user to specify the set of input 60 and output 30 pods, sensors 70, communications interface devices 80, and communication devices 40 needed or desired to support the intended mission or application. The configuration wizard software program 240 also sets the appropriate configuration, including activating the needed software modules, in IPU 20. These software modules may include but are not limited to: data filtering, data down-sampling, frequency analysis, detection processing, sensor control, data encryption, reformatting, timing for periodic sampling of sensor data, timing for periodic transmission of data or alerts, and device status monitoring.

IPU 20 also preferably includes reconfigurable hardware 260, operational software 265 and/or operational firmware 270. The reconfigurable hardware 260 may be, for example, field programmable gate arrays (FPGAs). The operational firmware 270 may be an EEPROM chip, an EPROM chip, a PROM chip and/or some other storage device. A variety of functional code may be located within reconfigurable hardware 260, operational software 265 and/or operational firmware 270. For example, conversion algorithms for converting input data to processed data may be contained within these elements. Data conversion functions may include but are not limited to conversion of analog signals to digital form, conversion of voltage ranges of digital signals, or reformatting the data stream in terms of word length or delimiter.

The input pods 60 and output pods 30 connect to the input/output interconnects 220 using a known connection mechanism, such as a standard pin connector or edge connector, to ensure inter-operability of any of the I/O pods with any of the input/output interconnects 220 affixed to the chassis of the IPU 20. The I/O pods may be of different types (e.g., serial pods, USB pods, analog pods, Ethernet pods, RS232 pods, custom pods, etc.) and comprise means for detecting or gathering data from a variety different sensor types (e.g., radiation, chemical, image, etc.), and sending different signal type to different communications devices (e.g., long-range, medium-range, short-range, etc.). Although FIG. 2 shows exemplary types of I/O pods 250 and 290, it will be readily understood that various alternative types and combinations of types of I/O pods may be used depending upon the mission in general and the communications and detection requirements specifically.

Each I/O pod 250/290 comprises means for converting an analog signal to a digital signal, a digital signal to an analog signal, or a digital signal from one signal type to a different digital signal type under software control. Each signal type is preferably mapped to a unique identifier enabling the software to select a proper conversion algorithm. In an exemplary embodiment the signals are converted to Peripheral Component Interconnect (PCI) bus signal type, although other signal types may be used.

Each input pod 60 comprises mechanical, electrical and data conversion means to facilitate conversion of the gathered data to common data for subsequent transmission via an IOP interconnect 220 to the communications bus 210 for use and processing by IPU 20. Each input pod 60 may include a processor as a component of the reconfigurable hardware. IPU 20 may also include a central processor as a component of the reconfigurable hardware. Each output pod 30 comprises mechanical, electrical and data conversion means to facilitate conversion of the common data after it is processed by IPU 20, if needed, before sending the data to the external communications device 40 via communications interface 80. Communications interface 80 may also conduct additional signal processing and other conversion functions in preparing the data for receipt by IPU 20 or transmission by communications device 40.

IPU 20 further includes system memory 295 which can temporarily and permanently store system and sensed data, and software as required. Data contained in system memory 295 can be accessed and stored via connections to reconfigurable hardware 260 and I/O interconnects 220 with such data transfer preferably occurring via common bus 210. For example, sensor data may be stored for logging, for processing, or while it is awaiting transfer to output pods 30.

In a preferred embodiment of the present invention peripheral devices including sensors, communications devices and related interfaces as well as other devices for obtaining and processing data are mapped to one or more I/O pods. In a preferred embodiment, this is accomplished through software contained within IPU 20. In one embodiment peripheral mapping serves to match peripherals with one or more of eight input pods 60 and eight output pods 30 through the I/O interconnects 220, although any combination of software, firmware and/or hardware may be utilized to accomplish the peripheral mapping scheme. It is understood that greater or less than eight I/O pods may be employed and remain within the scope of this invention. The present invention provides flexibility in the number and types of sensors, and the number and types of communications devices that may be employed at one time, all of which communicate with one another under the control of IPU 20.

In one exemplary embodiment, eight data channels are provided. The eight data channels are multiplexed so that any of the eight input channels can be mapped to any of eight output channels. This multiplexing operation is preferably software programmable, and as described earlier, this programming operation is reconfigurable as needed. An I/O Route Table maps the 8 channels of data to a driver I/O address. The I/O Routing operation is preferably software programmable. The Driver I/O Address Table is fixed software addressable and may include interfaces with various exemplary I/O pods, including those shown in FIG. 2 (USB, RS232 or some other specialized protocol).

In one exemplary sensor embodiment, an image sensor may be connected to a USB input pod that in turn communicates with the IPU 20 via I/O interconnect 220. After the data is processed and/or converted, it is transmitted from IPU 20 to another I/O interconnect 220. This other I/O interconnect 220 may be in turn be connected to an Ethernet output pod, for example, that interfaces with a long-range communications device) which serves to wireless transmit the captured data to a remote location.

If a different parameter, radiation for example, was sought to be monitored using the same IPU 20, a different sensor may be attached to a separate input pod for data gathering. This sensor would also be able to communicate captured data via common bus 210 of IPU 20 to, for example, the same Ethernet output pod that interfaces with a long-range communications device for data transmission. As described above, this “reconfiguration” of the internal data path and conversion may be accomplished remotely through the configuration device 15 which may be located remotely from IPU 20 and all related pods. Notwithstanding the obvious advantages of remote reconfiguration as discussed above, physically swapping one sensor (or one communications device) for another in the field does not take full advantage of all the benefits of the present invention.

Accordingly, in another embodiment, a plurality of different sensor types (e.g., chemical, image, seismic) 70 are connected to a corresponding plurality of input pods 60 (e.g., analog, USB and serial), which are in turn connected to IPU 20 via multiple input/output interconnects 220. Also, a plurality of different external communication device types (e.g., long-range and medium-range communications units) 40 are connected to a corresponding plurality of output pods 30 (e.g., Ethernet or Internet) possibly via one or more communication interface devices 80, which are in turn connected to IPU 20 via the input/output interconnects 220.

In such a configuration, each input pod on the sensor side can communicate, via IPU 20 and bus 210, with any of the output pods on the communications side, whether in a discrete time sequential mode, or simultaneously. That is, the sensor data from multiple inputs can be relayed to a remote monitoring station continuously or periodically according to a preset schedule or according to values in the data stream (e.g., alerts). Alternatively, some of the sensor data can be relayed continuously (e.g., low bandwidth data) while data from other sensors (e.g., video or other high bandwidth data), can be sent periodically after down-sampling, on demand, or based on conditions in high bandwidth or other sensor data streams. Also, one or more of the input pods 60 on the sensor side can communicate, via IPU 20 and communications bus 210, with any of the output pods 30 on the communications side, whether in a discrete time sequential mode, or simultaneously. That is, the input data can be channeled to any of the output pods 30 based on either preset conditions, on demand or based on conditions within the data stream. Since the I/O interconnects 220 are standardized, and the I/O pod connections are standardized, any input channel can be mapped to any output channel regardless of the physical location of the I/O pod 60 (i.e. which slot in the IPU 20 the pod is plugged into).

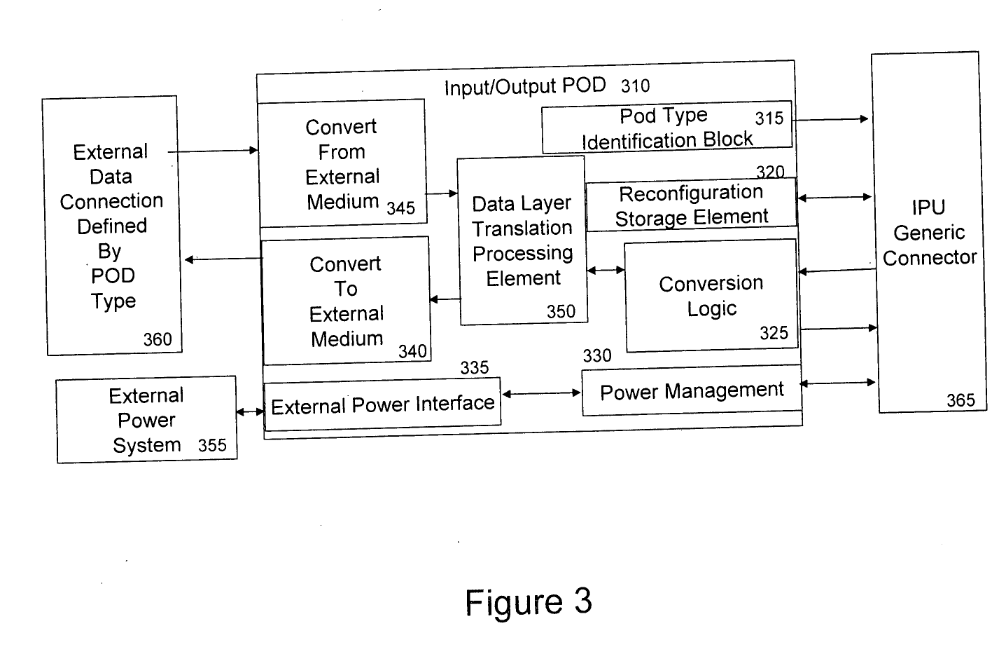

A more detailed discussion of the conversion data flow of the present invention is now provided in connection with FIG. 3. IPU 20 has as a primary function, the ability to translate and convert data from a variety of protocols so that many different input and output devices may communicate with one another as specifically configured by a user and as discussed above.

Turning now to FIG. 3, a more detailed block diagram of an exemplary I/O pod 310 is provided along with some of its connections to external components in an exemplary embodiment. Each Input/Output Pod 310 may provide zero or more input paths and zero or more output paths to zero or more External Data Connections 360, each of which is defined by Pod Type. The Pod Type may be electrical, optical, radio, chemical, or any other known type of sensor or communications device.

Convert From External Medium 345 and Convert To External Medium 340 are functional capabilities within I/O pod 310 which convert data from external data connection 360 to the Input/Output Pod's internal data representation and from the Input/Output Pod's internal data representation, respectively. These conversions may include electrical level changes, optical conversion, analog to digital (A/D) conversion, digital to analog (D/A) conversions, radio reception or transmission, chemical data transfer, or any other means of converting the data representation of the external device (e.g. sensor, communications device) to the internal data representation of Input/Output Pod 310. It is not required that each Input/Output Pod 310 use the same internal data representation.

Data Layer Translation Processing Element 350 performs logical translations on the data obtained from/to the conversion functionality 340 and 345. This translation may involve removing packetization from the input data stream or adding packetization to the output data stream (e.g., adding a hardware address to the outgoing data stream such as Ethernet or wireless LAN). This translation may also involve changing input data units from volts to counts (i.e., an A/D conversion and scaling operation), decimation of data (e.g., for digital signal processing), changing from counts to amperes (i.e., a D/A conversion and scaling operation), or any other translation operation on the logical input data. Each Input/Output Pod type may have one or more Data Layer Translation Processing Elements 350.

Conversion Logic 325 converts the data to/from the Input/Output Pod's internal data representation to the generic format required by IPU 20. Conversion logic 325 performs clocking of data into/out of the IPU 20 and into Data Layer Translation Processing Element 350. Each Input Output Pod 310 may have or more Conversion Logic 325 functions. Each Input Output Pod 310 may be made capable of bi-directional operation to maximize flexibility and may perform the functions of either I/O Pod 250 or I/O Pod 290 in FIG. 2, for example.

External Power Interface 355 provides power to external devices. In one embodiment, External Power Interface 355 accepts power from an external power source such as a battery, generator, solar cell, or other power source and provides the means for remote sensing system 10 to operate from this power source. Power Management 330 controls power to/from Input Output Pod 310. Each Input/Output Pod 310 may contain one or more Power Management blocks 330. In a preferred embodiment, each Input/Output Pod 310 may be turned on or off under control of IPU 20 to minimize system power consumption.

Pod Type Identification Block 315 provides a unique identifier for each Input/Output Pod 310. At a minimum, this identification includes the Pod Type, but may contain other information including but not limited to serial number, date of manufacture, software/firmware revision, manufacturer, and use count. This information is read by IPU 20 to determine the Input Output Pod Type.

Reconfiguration Storage Element 320 provides a means to change the processing performed by Data Layer Translation Processing Element 350 and to change the characteristics of the other Input/Output Pod blocks. Each Input/Output Pod 310 may have one or more Reconfiguration Storage Elements 320.

IPU Generic Connector 365 provides the generic connection from each type of Input/Output Pod 310 to IPU 20. Each Input/Output Pod 310 must mechanically connect to IPU 20 via this connector 365. In a preferred embodiment, IPU Generic Connector 365 provides electrical data interfaces, electrical Pod Type Identification, and electrical Power Management interfaces. In other implementations, these connections may be made via optical, radio, chemical, or other means.

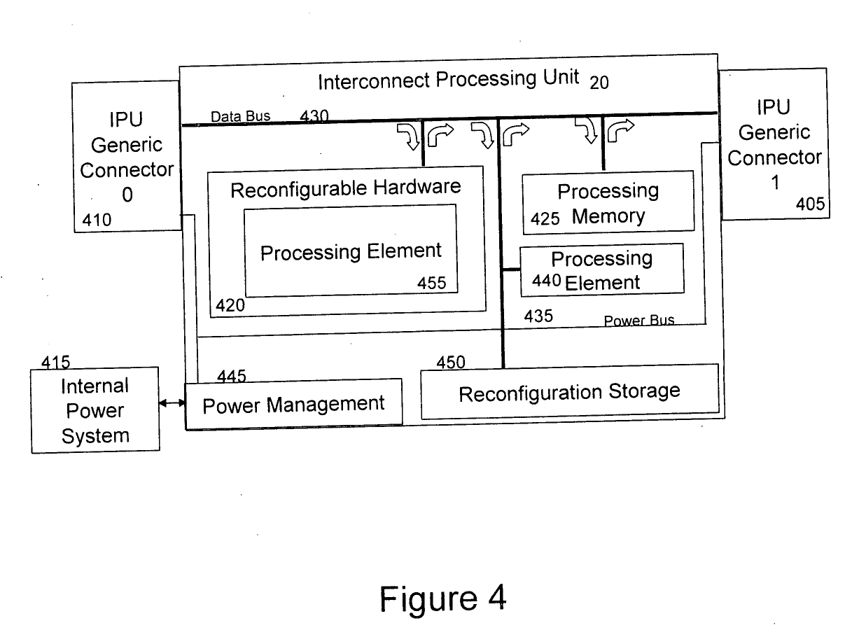

Referring now to FIG. 4, a detailed description of the data flow within IPU 20 is now provided. IPU 20 provides one or more Generic Connectors 405 and 410 that serve to attach Input/Output Pods 310. These Generic Connectors 405 and 410 may be used as an electrical interface in a preferred embodiment, although the “Generic Connectors” may comprise optical, radio, chemical, or other connection schemes for transmission and reception of data in other implementations.

The layout of each Generic Connector 405/410 is identical in a given IPU implementation; however, the actual definition for each electrical interconnect is defined by reconfigurable hardware 420 inside IPU 20. The number of Generic Connectors is dependent upon the given IPU implementation. At least one Generic Connector 405/410 is required for every IPU implementation.

For the purposes of FIG. 4, two Generic Connectors 405 and 410 are shown along with a single Data Bus 430 connecting the two. Data Bus 430 may be, but is not required to be, a full crossbar interconnect from each Generic Connector 405/410 to every other Generic Connector 405/410, depending upon the given IPU implementation. It is also understood that each Generic Connector 405/410 can simultaneously serve both input and output functions for IPU 20. Further, each Generic Connector 405/410 provides for reading the Input Output Pod Type from the Input Output Pod 310 connected to the Generic Connector 405/410.

The following data paths are possible in a preferred embodiment. Each possible combination of these data paths is also possible in a preferred embodiment. No data path requires software control. Direct memory access (DMA) is desirable but not necessary for a preferred implementation.
Generic Connector 0 to Generic Connector 1.
Generic Connector 0 to Processing Memory.
Processing Memory to Generic Connector 1.
Processing Memory to Reconfiguration Storage.
Processing Memory to Reconfigurable Hardware.
Generic Connector 0 to Reconfigurable Hardware.
Generic Connector 0 to Processing Element (NR).

Reconfiguration Storage 450 is preferably persistent storage that retains its contents during power-off of IPU 20. This storage 450 contains configuration data for Reconfigurable Hardware 420 as well as software for any Processing Elements 455. These processing elements may be implemented as either firmware or as software executed on a processing unit such as an FPGA or general purpose computer and are used to accomplish any of the data conversion, data processing, formatting, control or other operations of IPU 20.

IPU 20 may contain Reconfigurable Hardware 420 that contains one or more Processing Elements 455 embedded within Reconfigurable Hardware 420. IPU 20 may also contain one or more Processing Elements 440 not contained within Reconfigurable Hardware 420.

Reconfigurable Hardware 420 may be configured remotely through a Generic Connector 405/410 by reading data from this Generic Connector 405/410 and storing the configuration data in Reconfiguration Storage 450 or by changing Reconfigurable Hardware 420 directly.

Each Processing Element 440/455 may perform computation on the data received from any Generic Connector 405/410 dependent upon the software and firmware configuration of IPU 20. Each Processing Element 440/455 may store processed or unprocessed data in either Processing Memory 425 or a separate reconfiguration memory. Each Processing Element 440/455 may write data to any Generic Connector 405/410. It is understood that the actions of each Processing Element 440/455 are based on data and the software/firmware configuration. Power bus 435 permits power to be provided to and controlled by the necessary components as described above. Internal power system 415 and power management blocks 445 provide power and power control to and on behalf of IPU 20.

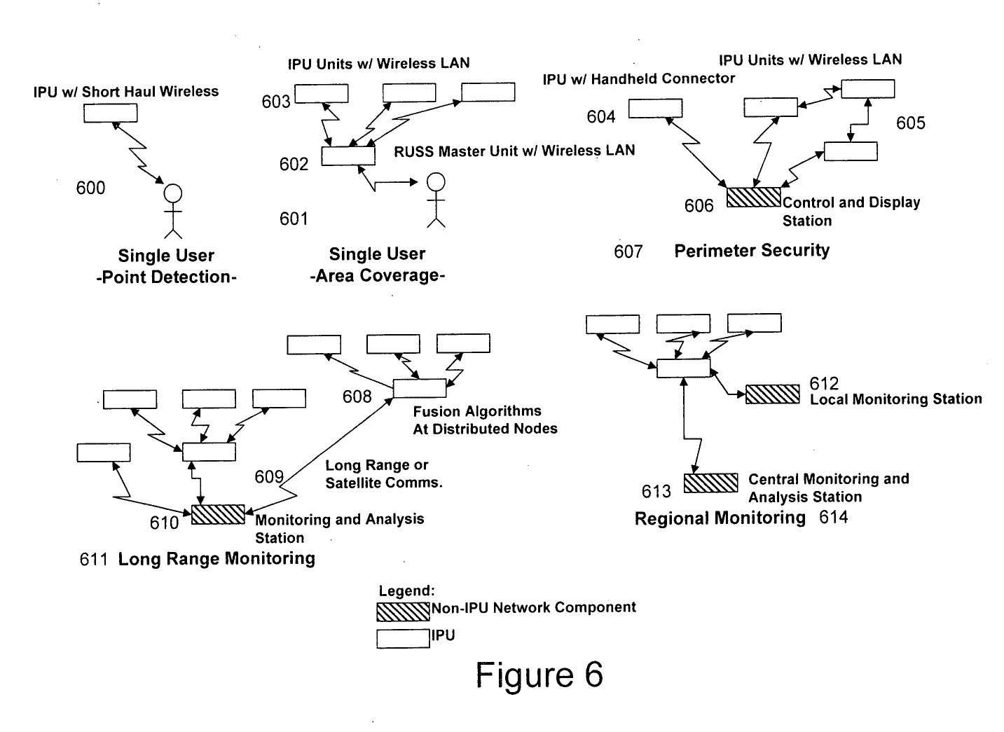

On the sensor side, after a particular configuration is selected via a user interface, one or more sensors are polled via a sensor controller, event scheduler and network manager. A sensor and detection processor, under control of the sensor controller, invokes the proper detection algorithm module, depending on the type of data that is sought to be gathered. On the communications side, a communications controller manages the formatting/encryption of the output data, and the communications to a communications device and/or a local network interface. The local network interface allows for each sensor station (IPU) to be integrated with other sensor stations (IPUs) or monitoring emplacements via a wireless local area network (LAN) for example, while still ensuring effective communication to a central receiving station. Longer range and regional monitoring could be accomplished with wide area networks (WANs) or satellite connections. Examples of possible interconnection and networking strategies are illustrated in FIG. 6.

Referring now to FIG. 6, there is shown exemplary methods for using the system of the present invention in various single user and system of systems scenarios. In one example, a single user in Point Detection Mode 600 may obtain sensor data and control sensor and system operation via a short-haul wireless communication subsystem. In another mode 601 for using system, one or more IPUs 603 are connected via a wireless Local Area Network (LAN) to a single Master IPU 602 which in turn provides bidirectional communication to a single user in Area Coverage Mode 601.

Also in FIG. 6, a single IPU 604 with a handheld connector for sensors, in conjunction with one or more IPUs 605 connected via a wireless LAN, communicate via the wireless LAN to a Control and Display Station 606 in Perimeter Security Mode 607.

In yet another mode, multiple IPUs may be deployed at a long range from a Monitoring and Analysis Station 610. Intermediate nodes 608 in the resulting network may perform data fusion and data reduction algorithms to reduce long range communication bandwidth requirements. Long range or satellite communications 609 may be used to operate in the Long Range Monitoring Mode 611, with data display and control of the network and IPUs being performed at a Monitoring and Analysis Station 610.

In still another mode, a number of IPUs may be monitored and controlled via Local Monitoring Stations 612. Concurrently, a Central Monitoring and Analysis Station 613 may view data and control the operation of multiple IPUs and IPU Master Units 608 to operate in the Regional Monitoring Mode 614.

Notwithstanding the above examples, it will be readily understood that many other possible usage scenarios are possible with the present invention. Further, each IPU and groups of IPUs may be present in multiple communication networks concurrently with multiple network topologies possible.

Now that a detailed description of the system of the present invention and each of the key components has been provided, summary of some of the key features of the present invention is now provided. As would readily be understood by one of skill in the art, this list is not intended to be exhaustive and the present invention offers additional features, advantages and benefits.
1. The Interconnect Processing Unit supports multiple Input/Output Interconnects.
2. A single Input/Output Pod (IOP) may be connected to each Input/Output Interconnect using a standard connection mechanism.
3. Multiple types of IOPs enable connection of various types of data devices.
4. Each specific IOP type provides mechanical, electrical, and data conversion of the input/output signal to the common bus.
5. The IPU hardware is dynamically reconfigurable under software control.
6. The Input/Output Pod (IOP) concept enables connection of multiple hardware interfaces into the Interconnect Processing Unit (IPU).
7. The Interconnect Processing Unit (IPU) enables switching of various digital signals from one format to another under software control.
8. The IPU enables switching of digital signals from one Input/Output Interconnect to zero, one, or more IOPs connected to the IPU under software control.
9. Each IOP provides a unique external interface and converts this external interface into a common interface through which the data is routed to zero, one, or more other IOPs for distribution to additional networks under software control.
10. Each IOP type may have a unique identifier that enables selection of the proper conversion algorithm by software.
11. The IPU provides capability to fuse data from zero, one, or more IOPs into zero or more output data streams.
12. The IPU provides storage for data from IOPs.
13. The IPU provides storage of IPU software.
14. The IPU performs its function under the control of internal software.
15. The IPU is reconfigurable by changing the internal firmware.

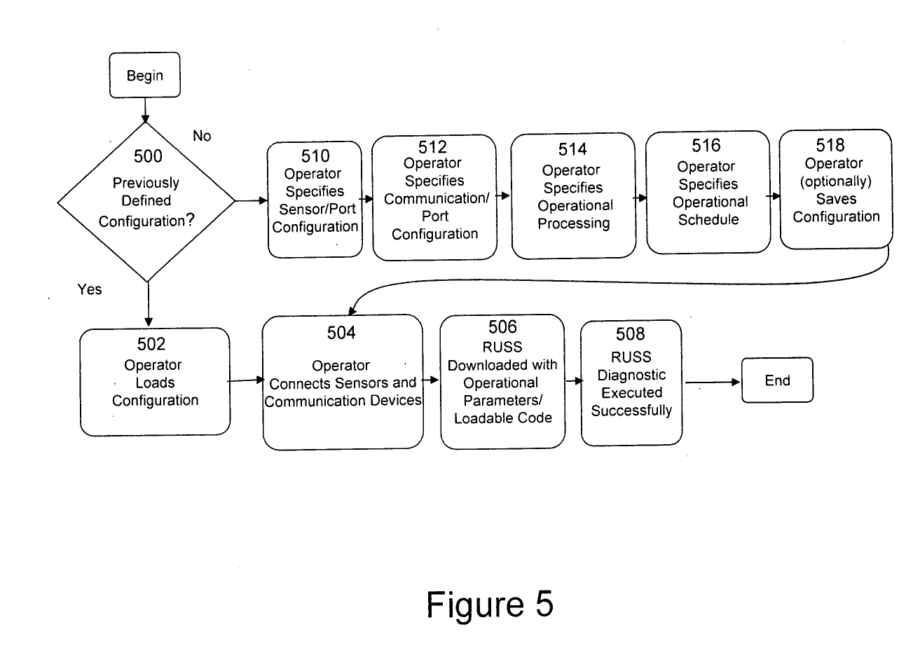

Referring now to FIG. 5, there is shown an exemplary processing unit configuration sequence as may be implemented through the methodology of the present invention. Through the use of the configuration device 15 and the configuration software 240, the user first determines whether the desired configuration method has been previously defined in step 500. If yes, the user loads the stored configuration 502. The particular sensors, communications devices and configuration protocol required for the desired mission is then activated 504. This may involve, if not previously done, plugging in the required cables at the required locations and connecting the necessary external components as required for the mission. Once this has been done the first time, remote changes to system configuration may be accomplished without the need for user presence at the IPU 20. In the next step 506 any necessary operational parameters and/or loadable code is downloaded to IPU 20 from configuration device 15. After the diagnostics are executed successfully 508, the sensor system is ready for operation.

If in FIG. 5 the user determines that the desired configuration has not been previously defined in step 500, the user specifies the desired sensor and port configuration (input) 510 and then the desired communications device and port configuration (output) 512. The configuration specifies which sensors or input data sources and which communications devices are associated with each I/O pod 250/290 location. Next, at step 514 the user specifies the operational processing to be performed on the data. The user then specifies the operational schedule 516, which determines the times at which sensors or input devices are polled or activated, which processing steps are performed and which output data is transmitted. The system then optionally saves 518 this new configuration in IPU 20 to make it available for later use. The process then continues with step 504 as described above, followed by steps 506 and 508 as previously described. The target time for reconfiguration process as described above is preferably 5 minutes or less. Such a rapid reconfiguration process allows for rapid deployment or redeployment of sensors and sensor networks to enable users to respond or adapt to changing conditions. the detection of emerging threats or parameters in near real-time.

Accordingly, the firmware, software and hardware of IPU 20 can be modified and updated remotely using an Internet or other communications protocol connected to configuration device 15 running configuration software 240.

It will be understood by one of skill in the art that the present invention may be employed in applications in which, in addition to sensing, the system also acts upon the environment. Alternatively, the system may only act upon the environment without a sensing functionality while still remaining within the scope and spirit of the present invention.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims, and by their equivalents.

What is claimed is:

1. A modular bus adapter comprising:
a communications bus;
a reconfigurable processing unit communicating with said communications bus, said reconfigurable processing unit operable to process input data to generate output data;
a configuration modification means communicating with said reconfigurable processing unit for modifying the operation of said reconfigurable processing unit;
first and second input/output interconnects communicating with said communications bus;
at least one input pod connected to said first input/output interconnect, for receiving said input data and transmitting said input data to said reconfigurable processing unit for processing to generate said output data; and
at least one output pod, connected to said second input/output interconnect, for transmitting said output data to a communications device;
wherein said configuration modification means is operable to modify the operation of said reconfigurable processing unit to permit said modular bus adapter to accept a plurality of different formats of input data and to transmit a plurality of different formats of output data.

2. The modular bus adapter of claim 1, wherein said reconfigurable processing unit comprises a plurality of conversion algorithms for converting input data to output data.

3. The modular bus adapter of claim 1, wherein said reconfigurable processing unit comprises means for reconfiguring hardware resident in said reconfigurable processing unit.

4. The modular bus adapter of claim 1, wherein said reconfigurable processing unit comprises means for reconfiguring firmware resident in said reconfigurable processing unit.

5. The modular bus adapter of claim 1, wherein said reconfigurable processing unit comprises means for reconfiguring software resident in said reconfigurable processing unit.

6. The modular bus adapter of claim 1 further comprising a configuration storage means, wherein said configuration storage means selectively communicates with said configuration modification means for modifying said reconfigurable processing unit.

7. The modular bus adapter of claim 1, wherein said at least one input/output pod is in communication with at least one physical sensor.

8. The modular bus adapter of claim 7, wherein said at least one input pod further comprises a data conversion means to facilitate communication of said input data to said communications bus and to said reconfigurable processing unit.

9. The modular bus adapter of claim 7, wherein said at least one output pod further comprises a data conversion means to facilitate communication of said output data from said reconfigurable processing unit to an external device via said communications bus.

10. The modular bus adapter of claim 1, wherein said at least one input/output pod comprises means for converting a digital signal from one signal type to a different signal type under software control.

11. A method for processing sensor data comprising the steps of:
(a) receiving sensor data through one or more input pods;
(b) routing said sensor data via a communications bus to a reconfigurable processing unit;
(c) processing said sensor data according to at least one predetermined criteria specified through a configuration modification means;
(d) routing said processed sensor data via said communications bus to at least one output pod;
(e) transmitting said processed sensor data to an external device;
wherein said configuration modification means is operable to modify the operation of said reconfigurable processing unit to permit said reconfigurable processing unit to accept a plurality of different formats of sensor data and to generate a plurality of different formats of processed sensor data.

12. The method of claim 11, wherein said reconfigurable processing unit comprises a plurality of conversion algorithms for converting input data to output data.

13. The method of claim 11, wherein said reconfigurable processing unit comprises means for reconfiguring hardware resident in said reconfigurable processing unit.

14. The method of claim 11, wherein said reconfigurable processing unit comprises means for reconfiguring firmware resident in said reconfigurable processing unit.

15. The method of claim 11, wherein said reconfigurable processing unit comprises means for reconfiguring software resident in said reconfigurable processing unit.

16. The method of claim 11 wherein said reconfigurable processing unit further comprises a configuration storage means and wherein said configuration storage means selectively communicates with said configuration modification means for modifying said reconfigurable processing unit.

17. The method of claim 11, wherein said at least one input pod is in communication with at least one physical sensor.

18. The method of claim 17, wherein said at least one input pod further comprises a data conversion means to facilitate communication of said input data to said communications bus and to said reconfigurable processing unit.

19. The method of claim 17, wherein said at least one output pod further comprises a data conversion means to facilitate communication of said output data from said reconfigurable processing unit to an external device via said communications bus.

20. The method of claim 11, wherein said at least one input pod and said one output pod comprise means for converting a digital signal from one signal type to a different signal type under software control.

21. A sensing system for remotely sensing data comprising:
at least one physical sensor for acquiring sensor data;
at least one interconnect and processing unit;
at least one communications device, said communications device capable of transmitting processed sensor data to a remote location;
wherein said at least one interconnect and processing unit comprises at least one input pod, at least one output pod, a reconfigurable processing unit for processing said sensor data and a communications bus permitting communication between and among said at least one input pod, said at least one output pod and said reconfigurable processing unit; and
wherein said reconfigurable processing unit is reconfigurable by a user to select between and among a plurality of configurations, said configurations being dynamically controllable via software.

22. The sensing system of claim 21 wherein data types are associated with unique identifiers to enable selection of one or more applicable conversion algorithms for use by said reconfigurable processing unit.

23. The sensing system of claim 21 wherein said configurations are controllable via internal firmware.

24. The sensing system of claim 21 wherein data received by a plurality of input pods are fused into a single output data stream.

25. The sensing system of claim 21 wherein said reconfigurable processing unit comprises a storage element for storing configuration data.

26. The sensing system of claim 21 wherein said reconfigurable processing unit provides dynamically selectable mapping of one or more input pods to one or more output pods.

27. The sensing system of claim 21 wherein said sensing system comprises a single master interconnect and processing unit and a plurality of separate interconnect and processing units, said plurality of separate interconnect and processing units being linked via a wireless LAN.

28. The sensing system of claim 27 further comprising a control and display station in communication with said master interconnect and processing unit and said plurality of separate interconnect and processing units.

29. The sensing system of claim 21 wherein said at least one interconnect and processing unit further comprises a storage element for storing said sensor data.

30. The sensing system of claim 21 wherein said at least one interconnect and processing unit further comprises a storage element for storing said processed sensor data prior to transmission to said remote location.

31. The sensing system of claim 21 further comprising a configuration device for configuring said reconfigurable processing unit.

32. The sensing system of claim 31 where said configuration device further comprises a software based configuration wizard.
